(19) United States
(12) Patent Application Publication
(10) Pub. No.: US 2012/0140232 A1
(43) Pub. Date: Jun. 7, 2012

(54) SPR optical fiber sensor and SPR sensing device using the same

(75) Inventors: Chung-Pei Lee, Taipei City (TW); Yu-Chia Tsao, Taipei City (TW); Jung-Chien Chang, Sanxia Township (TW)

(73) Assignee: Forward Electronics Co., Ltd, Taipei City (TW)

(21) Appl. No.: 13/064,002

(22) Filed: Mar. 2, 2011

(30) Foreign Application Priority Data
Dec. 7, 2010 (TW) 099142607

(51) Int. Cl. G01N 21/55; G02B 6/00

(52) U.S. Cl. 356/445; 385/12

(57) ABSTRACT

An SPR optical fiber sensor and an SPR sensing device using the same are disclosed. The SPR optical fiber sensor includes: an optical fiber substrate having a sensing area; a first metal layer disposed on the sensing area of the fiber substrate; and a second metal layer which is a gold layer and disposed on the first metal layer. In the present invention, two or more layers of different metals are stacked on the sensing area and thus the SPR measurable range can be promoted to improve the sensitivity and chemical stability of the SPR optical fiber sensor.

### BACKGROUND OF THE INVENTION

1. Field of the Invention

The present invention relates to a surface plasmon resonance (SPR) optical fiber sensor and an SPR sensing device using the same and, more particularly, to an SPR optical fiber sensor having multiple stacked metal layers thereon and an SPR sensing device using the same.

2. Description of Related Art

For applications in medical or environmental detection, rapid and accurate identification of the biomolecule species and concentrations is very important. Especially at the hazardous location, the member of the responding staff first has to identify the species and the concentrations of the harmful materials and then decides the subsequent procedures of treatment to minimize the risks based on the detection results. Accordingly, it is dramatically important that the analytical instruments with good accuracy, sensitivity, portability, and simplicity in operation procedures are applied.

Currently, SPR sensing devices based on SPR effects have been employed in the industry to detect the species and concentrations of the target biomolecules. Common SPR sensing devices possess the advantages as follows: (1) short time required for detection; (2) free from labeling the sample beforehand (i.e. label-free); (3) small amount of required sample; (4) real-time detection of the interactions between the sample and ligands thereof; and (5) high sensitivity of the detection.

A conventional SPR sensing device includes a laser light source, an incident light processor unit, a prism, a metal layer, an optical detector, a loading unit for a test sample, and a spectrometer. In the conventional SPR sensing device, the metal layer is located on the back surface of the prism. During the detection, the light output from the incident light source passes through the incident light processor unit and enters a side of the prism. Then, the light is reflected by the metal layer and emitted from another side of the prism. Subsequently, the light enters the optical detector. The optical detector converts the received photo-signal into an electro-signal and then provides the electro-signal to the spectrometer for constructing a spectrum.

However, the size of such the SPR sensing devices is huge, and the relative position among the components therein must be accurate. Otherwise, the metal layer located on the back surface of the prism will not correctly reflect the light emitted from the incidence light processor unit, and the light will not successfully reach the optical detector. Besides, the metal layer formed by sputtering on the prism is a gold or silver film mostly, and thus it is easy to restrict the range of the SPR response. Furthermore, when the metal layer is made of other material rather than gold, chemical stability thereof is poor so that the sensitivity of the detection will be easily influenced by the test sample. Moreover, in order to increase the sensitivity of the abovementioned structure, surface modification is often performed and thus gives complicated procedures of the manufacturing.

Therefore, there is an urgent demand to provide an SPR optical fiber sensor and an SPR sensing device with high sensitivity, wide applicability, and being easily made in the industry so as to speed up related detection.

### SUMMARY OF THE INVENTION

The object of the present invention is to provide a surface plasmon resonance (SPR) optical fiber sensor in which two or more layers made of different metals are stacked on the sensing area and thus combination of the SPR responses of the different metals can widen the SPR measurable range to promote sensitivity and chemical stability.

Another object of the present invention is to provide an SPR sensing device using the SPR optical fiber sensor of the present invention to increase the number of the detectable species of the test samples and the measurable environments.

In order to achieve the aforesaid objects, one aspect of the present invention provides an SPR optical fiber sensor which comprises: an optical fiber substrate having a sensing area; a first metal layer disposed on a sensing area of the fiber substrate; and a second metal layer which is a gold layer and disposed on the first metal layer.

Another aspect of the present invention provides an SPR sensing device which comprises: a light source unit for providing a light source; an SPR optical fiber sensor comprising: an optical fiber substrate having a sensing area, a first metal layer disposed on the sensing area of the fiber substrate, and a second metal layer which is a gold layer and disposed on the first metal layer, wherein the light source passes through the SPR optical fiber sensor to form a photo-signal; a light detector for detecting the photo-signal output by the SPR optical fiber sensor and converting the photo-signal into an electro-signal; a plurality of optical fibers respectively connecting the light source unit, the SPR optical fiber sensor, and the light detector; and a calculator-display unit connected to the light detector for receiving the electro-signal output from the light detector and displaying a result after calculation.

In the abovementioned SPR optical fiber sensor of the present invention, the first metal layer can be a metal layer made of one selected from a group consisting of Ag, Al, Cu, and an alloy thereof, and is preferably an Al layer. In addition, the thickness of the second metal layer can range from 1 nm to 10 nm, and preferably ranges from 3 mm to 7 mm. The thickness of the first metal layer can range from 20 nm to 100 nm, and preferably ranges from 30 nm to 50 nm.

In addition, the optical fiber substrate can be a side-polished optical fiber. The side-polished optical fiber can be made by the following steps. First, an optical fiber substrate is provided and the optical fiber substrate having a core layer and a cladding layer wrapping the core layer. Subsequently, the optical fiber substrate is side-polished to form a trench and the trench is deep enough to expose the core layer. Finally, the side-polished optical fiber can be obtained.

In the abovementioned SPR sensing device of the present invention, the light source unit can be a laser diode. The light detector can be a light diode detector and the optical fibers can be multi-mode or signal-mode optical fibers.

In generally, different metals possess different chemical stability and SPR response spectrums. The detectable species of the substances and the measurable environments in the SPR detection is influenced by chemical stability, and the response range and sensitivity is determined by the SPR response spectrums.

The present invention uses two or more metals stacked on the sensing area of the optical fiber substrate and the double- or multi-layered metal structure can be formed by a simple procedure in a chamber of a multi-source evaporation/sputtering apparatus so that the chemical stability and sensitivity of the SPR optical fiber sensor can be promoted. In addition, the SPR sensing device using the abovementioned SPR optical fiber sensor can have expanded detectable species and ranges of the substances.

Other objects, advantages, and novel features of the invention will become more apparent from the following detailed description when taken in conjunction with the accompanying drawings.

### BRIEF DESCRIPTION OF THE DRAWINGS

FIG. 1A is a perspective view of the SPR optical fiber sensor in Example 1 of the present invention;

FIG. 1B is a perspective view of the SPR sensing device in Example 2 of the present invention;

FIG. 2 shows an SPR spectrum profile of the SPR optical fiber sensors in Example 1 and Comparative Example 1 of the present invention;

FIG. 3 shows a spectrum profile in which the SPR optical fiber sensor of Example 1 detects oils with difference refractive indices; and

FIG. 4 shows a laser power profile in which the SPR optical fiber sensors of Example 1 and Comparative Example 1 detect oils with difference refractive indices.

### DETAILED DESCRIPTION OF THE PREFERRED EMBODIMENT

Because of the specific embodiments illustrating the practice of the present invention, one skilled in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements revealed in the drawings are not necessarily aspects of the practice, and quantity and shape thereof are optionally designed. Further, the design aspect of the elements can be more complex.

### Example 1

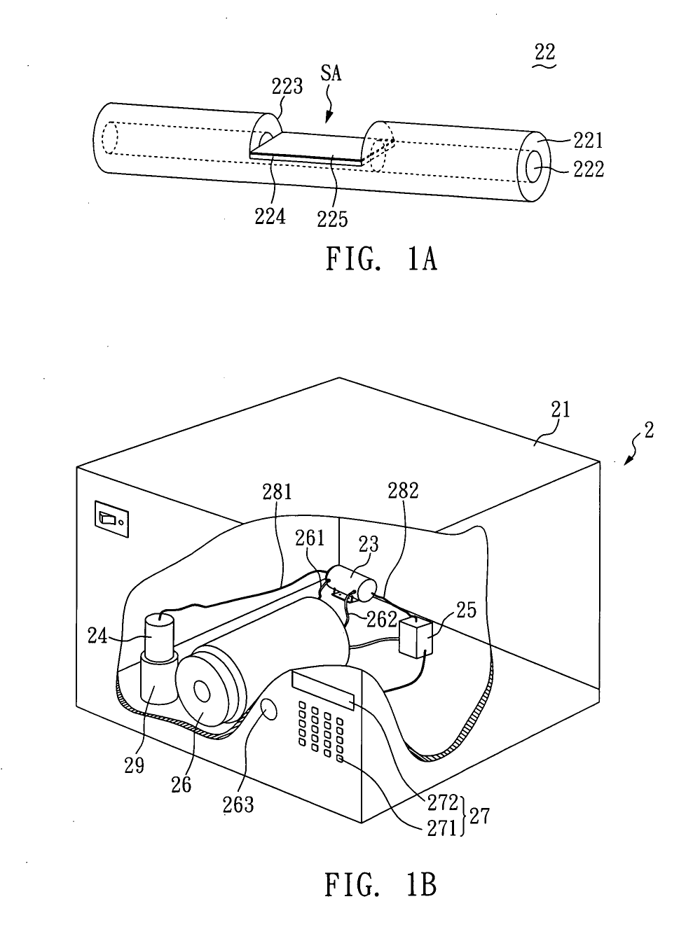

With reference to FIG. 1A, it is an enlarged view of the SPR optical fiber sensor 22.

As shown in FIG. 1A, the SPR optical fiber sensor 22 includes a core layer 222, a cladding layer 221 wrapping the core layer 222, a trench 223 exposing the core layer 222, a first metal layer 224 located on the surface of the core layer 222 in the trench 223, and a second metal layer 225 stacked on the first metal layer 224.

In the abovementioned SPR optical fiber sensor 22, the trench 223 can be formed by side-polishing or etching and can have a length of about 5 mm and a depth of about 62.5 μm. However, the length and depth of the trench 223 is not limited thereto and can be varied according to the species of the test sample and the environmental condition (e.g. refractive index of a solution). Besides, the first metal layer 224 and the second metal layer 225 can be formed on the surface of the trench 223 by DC sputter deposition, RF sputter deposition, evaporation deposition, or other known methods. Thus, the trench 223 is used as a sensing area SA.

The first metal layer 224 can be made a material selected from a group consisting of Ag, Al, Cu, and an alloy thereof, and its thickness can range from 30 nm to 50 nm. In the present example, an aluminum film is used as the first metal layer 224 and its thickness is about 35 nm. In addition, a gold film is used as the second metal layer 225 and its thickness is about 5 nm. Although the first metal layer 224 of the present invention is a single-layered structure, the first metal layer can be a multi-layered structure made of the metals depicted above.

### Example 2

With reference to FIG. 1B, it is a perspective of the SPR sensing device 2.

As shown in FIG. 1B, the SPR sensing device 2 of the present invention includes: an outer casing 21, a light source unit 24, a sample tank 23, an SPR optical fiber sensor 22, an optical detector 25, a sample reservoir 26, a calculator-display unit 27, a plurality of optical fibers 281 and 282, and a power unit 29. In the SPR sensing device 2, the SPR optical fiber sensor of Example 1 is employed as the SPR optical fiber sensor and located in the sample tank 23.

In the present example, the light source unit 24 is a laser diode, and the light source output from the light source unit 24 is transmitted to the light source unit 22 in the sample tank 23 via the multi-mode fiber 281. Subsequently, the photo-signal passing through the SPR optical fiber sensor 22 and carrying the information related to the sample is transmitted to the optical detector 25 by another multi-mode fiber 282. Later, the optical detector 25 converts the photo signal into a corresponding electro signal and then transmits the electro signal to the calculator-display unit 27 for further detailed calculation.

In the present example, the calculator-display unit 27 is used to control the operation of the SPR sensing device 2 of the present invention, and receives the control instructions entering through the button set 271 located on the surface of the outer casing 21. Besides, the results of calculation by the calculator-display unit 27 are displayed on the screen 272 located on the surface of the outer casing 21. The power for driving the SPR sensing device 2 of the present invention is supplied by a power supply unit 29. The power supply 29 can be a plug with a transformer or a battery set (applied to the occasions where commercial power supply is not available, such as outdoors detecting application).

In addition, the sample reservoir 26 is filled with a solution that can provide a suitable environment for the detection. The solution flows inward and outward respectively through ducts 261 and 262 such that the sample tank 23 is maintained in a stable condition (e.g., the conditions of a specific temperature, pH value, refraction index, etc). The solution can be introduced into the sample reservoir 26 through the inlet 263 located on the surface of the outer casing 21. Besides, the sample reservoir 26 further includes a manifold valve (not shown) to control the flow of the solution.

The SPR optical fiber sensor 22 located in sample tank 23 can be connected with the multi-module fibers 281 and 282 at two opposite ends thereof through optical-fiber connectors. Thus, the light source output from the light source unit 24 can enter the SPR optical fiber sensor 22 located in the sample tank 23 via the multi-module fiber 281, then pass through the SPR optical fiber sensor 22, and finally reach the optical detector 25.

Meanwhile, since the test sample is detected on the second metal layer 225 of the SPR optical fiber sensor 22, SPR effects occur in the SPR optical fiber sensor 22. In other words, after the light source passes through the SPR optical fiber sensor 22, the spectrum distribution of the light changes according to the specie, concentration, refractive index of the test sample or the interaction between the test sample and the second metal layer 225. Then, the formed photo-signal reaches the optical detector 25 via the multi-module fiber 282. The optical detector 25 converts the received photo-signal into an electro-signal and transmits the electro-signal to the calculator-display unit 27 connected therewith. After proper procedures are executed in the calculator-display unit 27, the calculator-display unit 27 can display a spectrum distribution chart on the screen 272 according the custom mode set by the user. Alternatively, the species or concentration of the sample can be displayed directly on the screen 272 after comparison between the result and the database beforehand stored in the memory of the calculator-display unit 27.

### Comparative Example 1

The SPR optical fiber sensor of the present comparative example is substantially similar to that of Example 1 except a single-layered Au structure in a thickness of 40 nm is formed on the sensing area of the SPR optical fiber sensor of the present comparative example.

### Test Example 1

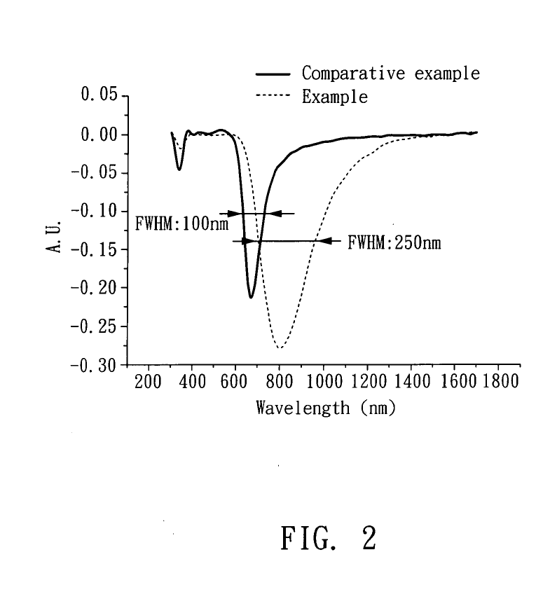

In the SPR sensing device of Example 2, the SPR optical fiber sensors of Example 1 and Comparative example 1 were tested to determine their wavelengths of SPR. The results are shown in FIG. 2.

The spectrum of FIG. 2 shows that the full width at half maximum (FWHM) of the SPR optical fiber sensor with a single-layered metal structure (Comparative example 1) corresponds the wavelength in a span of 100 nm. By contrast, the FWHM of the SPR optical fiber sensor with a double-layered metal structure (Example 1) corresponds the wavelength in a span of 250 nm.

Based on that the span of the wavelength corresponding the FWHM is increased from 100 nm to 250, it can be known that the double-layered metal structure can increase the span of the wavelength of SPR.

### Test Example 2

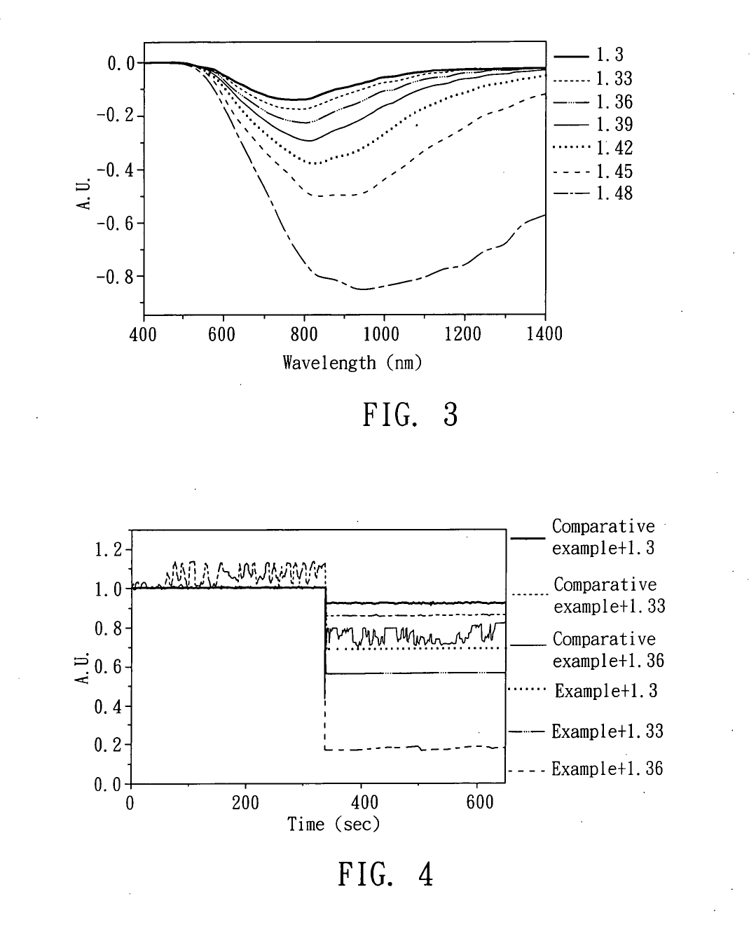

In the SPR sensing device of Example 2, the SPR optical fiber sensor of Example 1 was tested to determine the respective responses to oils with different refractive indices (i.e. 1.3, 1.33, 1.36, 1.39, 1.42, 1.45, and 1.48). The results are shown in FIG. 3.

The spectrum of FIG. 3 shows that the SPR optical fiber sensor with a double-layered metal structure (Example 1) can clearly distinguish among the oils with different refractive indices. Even though two oils have only a difference of 0.03 in their refractive indices, the SPR optical fiber sensor of the present invention still can distinguish between the oils.

### Test Example 3

In the SPR sensing device of Example 2, the SPR optical fiber sensors of Example 1 and Comparative example 1 were tested to determine the respective responses to oils with different refractive indices (i.e. 1.3, 1.33, and 1.36). The results are shown in FIG. 4.

The spectrum of FIG. 4 shows that the decrease of the laser power is more significant in the SPR optical fiber sensor of Example 1 than in that of Comparative example 1 when the oils with different refractive indices are tested. This result demonstrates that the SPR optical fiber sensor with a double-layered metal structure (Example 1) have better sensitivity.

In conclusion, the conventional technique utilizes a prism serving as an optical component to achieve total reflection and regulates the wavelength of the incident light for various samples to respond. Thus, the conventional technique can be used in the detection of various samples. However, the apparatus using the prism in the conventional technique have drawbacks such as huge volume, requirement of absolutely accurate relative position among the components, limitation of the range of the SPR response, and poor sensitivity.

By contrast, the present invention utilizes an optical fiber serving as an optical component to achieve total reflection. Although the use of the optical fiber will restrict the wavelength range of the incident light achieving the total reflection and various samples will respond in different ranges of the wavelength (leading to poor sensitivity of conventional optical fiber sensors or being not applicable in the range of the wavelength response), the stack of two or more metal layers on the sensing area of the optical fiber substrate in the present invention can widen the measurable range of the SPR response. Hence, the present invention can overcome abovementioned shortcomings such as poor sensitivity and being not applicable in the range of the wavelength response as well as problems of using a prism in the conventional technique.

Besides, in the manufacturing of the SPR optical fiber sensor of the present invention, double- or multi-layered metal structure can be formed by a simple procedure in a chamber of a multi-source evaporation/sputtering apparatus. Therefore, the formed SPR optical fiber sensor can possess better chemical stability and sensitivity and is suitable to be applied in the wider detection for various species of substances.

Although the present invention has been explained in relation to its preferred embodiment, it is to be understood that many other possible modifications and variations can be made without departing from the scope of the invention as hereinafter claimed.

What is claimed is:

1. A surface plasmon resonance (SPR) optical fiber sensor comprising:
an optical fiber substrate having a sensing area;
a first metal layer disposed on a sensing area of the fiber substrate; and
a second metal layer which is a gold layer and disposed on the first metal layer.

2. The SPR optical fiber sensor as claimed in claim 1, wherein the first metal layer is a metal layer made of one selected from a group consisting of Ag, Al, Cu, and an alloy thereof.

3. The SPR optical fiber sensor as claimed in claim 2, wherein the first metal layer is an Al layer.

4. The SPR optical fiber sensor as claimed in claim 3, wherein a thickness of the second metal layer ranges from 1 nm to 10 nm.

5. The SPR optical fiber sensor as claimed in claim 4, wherein a thickness of the first metal layer ranges from 20 nm to 100 nm.

6. The SPR optical fiber sensor as claimed in claim 1, wherein the optical fiber substrate is a side-polished optical fiber.

7. An SPR sensing device comprising:
a light source unit for providing a light source;
an SPR optical fiber sensor comprising: an optical fiber substrate having a sensing area, a first metal layer disposed on the sensing area of the fiber substrate, and a second metal layer which is a gold layer and disposed on the first metal layer, wherein the light source passes through the SPR optical fiber sensor to form a photo-signal;
a light detector for detecting the photo-signal output by the SPR optical fiber sensor and converting the photo-signal into an electro-signal;
a plurality of optical fibers respectively connecting the light source unit, the SPR optical fiber sensor, and the light detector; and
a calculator-display unit connected to the light detector for receiving the electro-signal output from the light detector and displaying a result after calculation.

8. The SPR sensing device as claimed in claim 7, wherein the first metal layer is a metal layer made of one selected from a group consisting of Ag, Al, Cu, and an alloy thereof.

9. The SPR sensing device as claimed in claim 8, wherein the first metal layer is an Al layer.

10. The SPR sensing device as claimed in claim 9, wherein a thickness of the second metal layer ranges from 1 nm to 10 nm.

11. The SPR sensing device as claimed in claim 10, wherein a thickness of the first metal layer ranges from 20 nm to 100 nm.

12. The SPR sensing device as claimed in claim 7, wherein the optical fiber substrate is a side-polished optical fiber.
